(19) United States
(12) Patent Application Publication
(10) Pub. No.: US 2009/0259566 A1
(43) Pub. Date: Oct. 15, 2009

(54) System, Method, and Apparatus For Organizing and Implementing A Real-Life, Physical Activity

(75) Inventors: William Collins White, III, Cicero, NY (US); John Thomas Ebensperger, Camden, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Action Airgun LLC, East Syracuse, NY (US)

(21) Appl. No.: 12/487,128

(22) Filed: Jun. 18, 2009

Related U.S. Application Data
(63) Continuation-in-part of application No. 11/951,555, filed on Dec. 6, 2007.
(60) Provisional application No. 60/868,739, filed on Dec. 6, 2006.

(51) Int. Cl. G06Q 30/00; G06F 19/00

(52) U.S. Cl. 705/26; 700/91

(57) ABSTRACT

A process for distributing information and processing results for an airgun shooting sport with geographically diverse participants may include receiving registration data from a user, distributing course-of-fire data, and receiving a metric from the user. The course-of-fire data may define at least one parameter of a shooting sport match. The user may record an overall elapsed time associated with shooting targets specified in the course-of-fire data and send this score to a server. The server may rank order the scoring data, providing a benchmark for competition among the geographically diverse users. Furthermore, the server may distribute a rule-set to the user. The rule set may define the real-life, physical activity and the rule-set may require a standard item for participation. For example, the standard item may include the disclosed foam airgun target.

### CROSS-REFERENCE TO RELATED APPLICATIONS

This application is a continuation-in-part of U.S. application Ser. No. 11/951,555, entitled “System, Method, and Apparatus for Organizing and Implementing a Real-life, Physical Activity,” filed Dec. 6, 2007 which claims the benefit of U.S. Provisional Application No. 60/868,739, entitled “System, Method, and Apparatus for Organizing and Implementing Real-life Game and Sport Activities” filed Dec. 6, 2006, each of which is incorporated herein by reference.

### TECHNICAL FIELD

The present disclosure relates to a process and system for distributing information to and processing results from geographically diverse participants in an airgun shooting sport. The present disclosure also relates to the standard equipment and rules associated with an airgun shooting sport that enables geographically diverse participants to compete against each other.

### BACKGROUND

There exists within the United States, and the world in general, many millions of active participants in the shooting sports. The nature of real-life, physical activities, such as shooting sports, presents a problem for geographically diverse participants. Because of the geographic distance between the players, it may be difficult for them to participate and/or compete in such real-life, physical activities together.

Console-based computer gaming networks may enable geographically diverse members to play virtual games with one another; however, computer gaming networks are limited to virtual (i.e., non-physical) games. Computer gaming networks do not consider the real-life, physical skill, speed, agility, and attributes associated with real-life, physical activities. A computer gamming network may emulate a shooting sport with an electronic game controller in the shape of a gun that is pointed at virtual targets on a television screen; however, such a computer game is not real life. It is virtual, and it does not include a real gun, real projectiles, and real targets, for example. As a result, the virtual computer game is not suitable for enabling geographically diverse people to participate in real-life, physical activities together.

Shooting sports may include competitive tests of proficiency with firearms and airguns, for example. The tests of proficiency may include accuracy and speed. Shooters are often, by way of geographic location, local laws, and/or the weather, unable to participate as much as they would otherwise like in shooting sports. Many shooters are also geographically distant from any number of competitive shooting events and are unable to participate to the degree they may desire. A traditional shooting sport tournament, held at a single, physical location, may require all participants to travel to that single, physical location.

The airgun participant may desire a forum for game play not limited to a single location and/or region. The airgun participant may desire competing with geographically diverse competitors without having to travel. The airgun participant may desire targets that provide an accurate representation of being hit, that are not susceptible to false positive hits from ricochets, that are safe to use, and that have an exciting action-response when struck. The airgun participant may desire a target stand that is safe to use, compact to ship and store, and versatile enough to provide many different arrangements for targets. The airgun participant may desire standard equipment that provides a “level playing field” for all participants. With standardized equipment, airgun participants may judge the differences in shooting skill without the results being skewed by advantages in equipment and/or environment.

### SUMMARY

The following is a simplified summary of the embodiments in order to provide a basic understanding of some of the aspects of the embodiments. This summary is not intended to identify key or critical elements of the embodiments or to define the scope of the invention.

The systems and methods combine real-life players engaged in physically playing a sport using standard equipment and rules with online community/internet usage aspects. In one embodiment, the systems and methods allow competitive shooting sport groups and provide a connection between the shooter community via the use of the Internet to support the sport, including distribution of a course-of-fire to all participants and collection of scores. Results, including ranking of participants by accuracy and/or speed, may be made available or output to the participants.

A user and a server may interact in a process for distributing information and processing results from a real-life, physical activity, such as an airgun shooting sport. The participants may be geographically diverse from one another. The server may receive registration data indicative of the user. The server may deliver to the user course-of-fire data. The course-of-fire data may define at least one parameter of a shooting sport match. For example, the course-of-fire data may specify the placement and orientation of airgun targets and/or airgun stands. The course-of-fire data may define at least one metric associated with the shooting sport match. For example, the course-of-fire data may specify that the user record an overall elapsed time associated with shooting the specified targets. The user may record this overall time, and the server may receive scoring data from the user. The scoring data may be associated with the at least one metric. The server may associate the scoring data with the registration data and store the scoring data and the registration data. The server may provide ranking data, and the sever may order and/or filter the ranking data according to an aspect of the registration data. For example, the server may order the ranking data according to age groups of the users. The rank ordered data may be available to the users via the server, and it may serve as a benchmark for competition among the users with respect to the activity.

Furthermore, the server may distribute a rule-set to the user. The rule set may define the real-word, physical activity and the rule-set may require a standard item for participation. For example, to provide a “level playing field,” the rule-set may require that all airgun shooting sport participants use the same model airgun, stand, targets, and/or timer. The user may be provided at least one standard item. For example, the server may include an online-store portion that sells the at least one standard item.

The at least one standard item may be provided as part of a kit. A kit may include an airgun, at least one airgun target, at least one airgun target stand, an airgun shot timer, and instructions. The instructions may direct a user to register at a designated website and download a course-of-fire document that defines an orientation of the at least one airgun target and the at least one airgun target stand. The instructions may direct the user to record an elapsed time associated with shooting the at least one target with the airgun and report the elapsed time at the designated website.

The airgun target may include a striking portion, a vertex portion, and base portion. The vertex portion may be connected to an edge of the striking portion. The base portion may extend from the vertex portion. The striking portion and the base portion may define an acute angle. The target may be oriented such that the acute angle faces the oncoming airgun pellet. The target may have a void in the base portion. The void may lessen the overall weight of the target while maintaining the target's stability. Thus, enjoyment in the shooting sport may be greater because of the improved toppling action of the reduced-weight target.

The airgun target stand may define a flat position and an assembled position. The airgun target stand may have printed thereon a number of individually identifiable cells. Each cell may be identified with a number and/or a code. The course-of-fire data may specify the position of the targets with reference to this number and/or code. The individually identifiable cells may be hexagonal in shape.

Additional features and advantages of the embodiments will be made apparent from the following detailed description of illustrative embodiments that proceeds with reference to the accompanying drawings.

### BRIEF DESCRIPTION OF THE DRAWINGS

FIG. 1 depicts an example system for distributing game information and processing game results;

FIGS. 2A-C depict a client, server, and event management portion, respectively, for use in an example system for distributing game information and processing game results;

FIG. 3 depicts example course-of-fire data;

FIGS. 4A-C depict an example airgun target in front, side, and bottom views respectively;

FIGS. 4D-H depict an example airgun target, in front, side, bottom, front perspective, and rear perspective views, respectively.

FIG. 5 depicts an example target stand, assembled, in isometric view;

FIG. 6 depicts an example target stand, unassembled, in a top view;

FIG. 7 depicts two example target stands in an example configuration;

FIG. 8 depicts an example target stand, unassembled, in a top view with an example target placement grid;

FIG. 9 depicts a flowchart of an example process for providing a distributed shooting sport;

FIG. 10 depicts an example webpage for distributing game information and processing game results;

FIG. 11 depicts an example registration webpage;

FIG. 12 depicts an example download center webpage from which a course-of-fire may be distributed;

FIG. 13 depicts an example post scores webpage via which results may be uploaded from the participants;

FIG. 14 depicts an example standings webpage for displaying results data; and

FIG. 15 depicts an example online store webpage from which one or more standard items may be purchased.

### DETAILED DESCRIPTION

The systems and methods include a combination of an electronic system for distribution of rules and collection of results (e.g., metrics) and user interaction in a real-life physical sport or activity using standard equipment. In one preferred embodiment, the sport or activity includes shooting sports. As used herein, shooting sports may include competitive sports involving tests of proficiency (e.g., accuracy and/or speed) using airguns. The systems and methods provide a geographically distributed competitive shooting sport harnessing the power of the internet to allow shooters to compete globally on a level playing field in timed shooting events.

The shooting sport may include an action shooting sport. An action shooting sport includes non-traditional shooting sports, generally characterized by rapid movement within each shooting stage, although fast, accurate shooting (mainly with airguns) requiring little or no movement may also be included in the action shooting category owing to the rapidity of firing. The action shooting sport may include a dynamic component to the shooting requirements of the participant. For example, the participant may be directed to physically move from one spot to another while firing at targets.

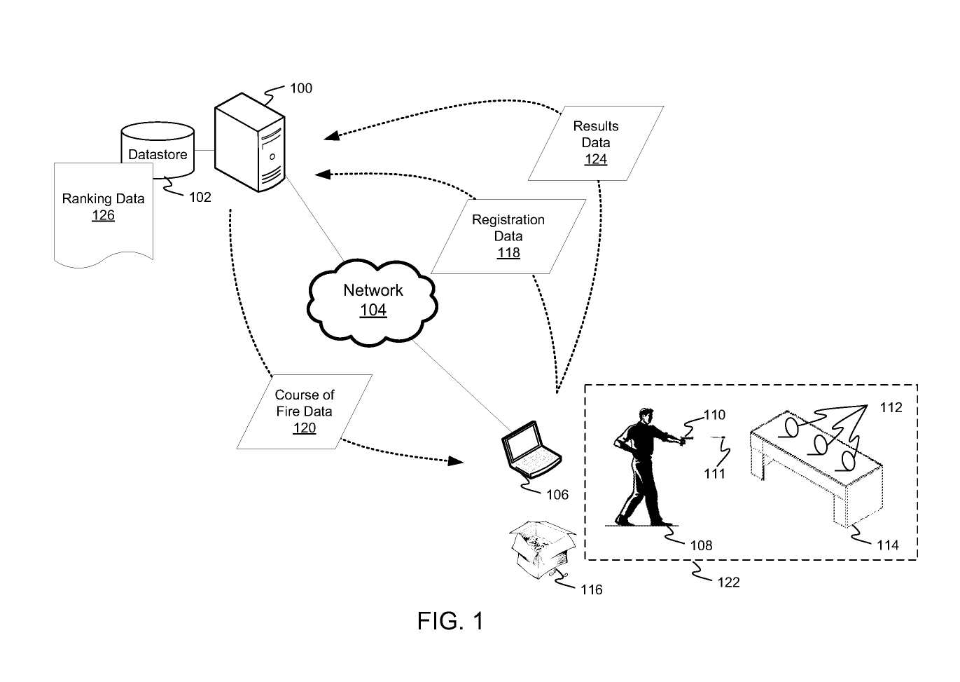

FIG. 1 depicts an example system for distributing game information and processing game results. The system may include a server 100 in connection with a datastore 102, a network 104 in communication with the server 100, and a user node 106 in connection with the network 104. The system may enable geographically diverse users 108 to participate in a standardize real-life, physical activity. The geographically diverse users 108 may each participate in a recreational and/or sporting activity, such as an airgun shooting sport for example. The system enables each user 108 to participate in the activity under a dynamic, yet uniform, set of rules and/or conditions. This “level playing field” may enable geographically diverse users 108 to compete against one another in activities that may otherwise necessitate collocation of the participants at the same and/or centralized location.

The server 100 may be any computing device suitable for sending, receiving, and/or processing data. For example, the server 100 may be a web server, an e-commerce server, an application server, a server farm, or the like. The server 100 may include a processor and memory. The server 100 may be in communication with the network 104. The server 100 may include hardware suitable for transmitting data to and receiving data from the network 104.

The datastore 102 may be any storage device suitable for storing data. For example, the datastore 102 may be hard the drive, flash drive, database, Storage Area Network (SAN), or the like. The datastore 102 may be in communication with the server 100. The server 100 may store and retrieve data from the datastore 102. The datastore 102 may be redundantly connected to the server 100. The datastore 102 may have redundancy in storage. For example, the datastore 102 may include Redundant Arrays of Inexpensive Disks (RAID) drives. The datastore 102 may include a structure data component such as a database management system.

The network 104 may be any system, subsystem, and/or component suitable for communicating data. The network 104 may be the Internet, for example. The network 104 may be an Internet Protocol (IP) network. For example, the network 104 may be an Integrated Services Digital Network (ISDN), a frame relay network, a wireless network such as WiFi, WiMax, Global System for Mobile Communications (GSM), or the like. The network 104 may provide connectivity between the server 100 and one or more user nodes 106.

A user node 106 may connect to the network 104 via an access network (not shown). For example, a user node 106 may connect to the network 104 via a cable modem, telephony modem, a WiFi network adapter, or any other suitable access network that may provide data connectivity between the network 104 and the user node 106. The user node 106 may be any device suitable for sending, receiving, processing, and/or displaying data in connection with the server 100. For example, the user node 106 may be a laptop computer, a personal computer (PC), a handheld device such as a PDA, smart phone, ultra-mobile PC, or the like. The user node 106 may be a kiosk computer, public Internet terminal, or the like.

The user 108 may access the server 100 via the user node 106. For example, the user 108 may access the server 100 via the World Wide Web (WWW) user node 106 may establish a Hypertext Transfer Protocol (HTTP) connection with the server 100. The server 100 may present to the user 108 a website. The user 108 may be able to interact with the website.

The website may contain information related to a real-life, physical activity. For example, the real-life, physical activity may include an action sport, such as airgun shooting sports. In an example embodiment, the airgun shooting sport may include timed target shooting. However it is appreciated that the real-life, physical activity may include any competitive sport, such as running, swimming, basketball, tai chi, horseshoes, cornhole, bocce, or the like.

The real-life, physical activity may include any competitive and/or recreational activity that involves physical interaction with tangible, real-world objects. In an embodiment, the physical interaction with tangible, real-world objects may be described with at least two tangible objects. The physical interaction may include a first tangible object in direct interaction with a user 108 and a second tangible object in isolation (i.e., not in physical contact and/or electrically connected) to the user 108 and/or the first tangible object. The second tangible object may be isolated over a distance from the user 108 and/or the first tangible object. In participation of the real-world, physical activity, the first tangible object may interact with the isolated second tangible object. For example, in an airgun shooting sport a first tangible object may include an airgun 110 and pellet 111. The first tangible object may interact with the user 108 by the user 108 directly holding the airgun 110 and depressing the trigger. The second, isolated object may include one or more airgun targets 112 and/or one or more airgun target stands 114. In participation of the activity, shooting the target 112, the user 108 is isolated from directly interacting with the target 112. The first tangible object may interact with the second tangible object when the user 108 depresses the trigger of the airgun 110 and the pellet 111 strikes the target 112.

In the alternative, the physical interaction with tangible, real-world objects may be described with at least three tangible objects. A first tangible object, such as an airgun 110 may interact directly with a second tangible object such as the pellet 111. The participant may fire the pellet at a third tangible object, such as the target 112. The third tangible object may be isolated from the first tangible object, and the second tangible object may physically impact the third tangible object. The airgun 110 may be isolated from the target 112. The airgun 110 and the target 112 may be electrically and/or physically separate. The airgun 110 may fire the pellet 111 at the target 112. The pellet 111 may strike the target 112.

The use of standard items in participation of the real-life, physical activity may enable uniform competition among all users 108. More than one user 108 may participate in the activity. The users 108 may be geographically diverse to one another. Because all of the users 108 may use items of the same specification, there may be parity among the results of their participation in real-life, physical activity. This allows a meaningful comparison of the results and ranking of participants to one another.

The real-life, physical activity may require at least one standard item for participation. For example, the activity of an airgun shooting sport may include standard items such as safety glasses, a standard airgun pistol 110, a standard magazine and/or pellets 111, a standard holster, a standard set of targets 112, and/or a standard set of target stands 114. For example, the standard for the airgun pistol 110 may be set as a specific make, model, manufacture, etc. The standard for the airgun pistol 110 may include a specified fire velocity, caliber, weight, size, accuracy, etc. For example, the standard magazines may include a specified capacity and a specified weight. The standard holster may include a standard size and material. The standard target 112 may include a standard size, weight, shape, or the like. A standard target stand 114 may include a specified size, shape, material, weight, depth, or the like.

In an illustrative scenario, the activity of cornhole may include standard items such as a regulation size board and holes and a regulation size bag filed with standard weight of corn. A user may throw the bags from a regulation distance to the board and record the number of bags landing on the board and in the holes. This score may be recorded and compared to that of other, geographically diverse cornhole players. For example, the activity of horseshoes may include standard throwing shoes and standard stakes. A user may throw the shoes and record the number of points following the standard and/or modified horseshoe rules. The score may be recorded and compared to that of other, geographically diverse horseshoe players. For example, indoor rock-wall climbing may include standard size and shape handholds arranged in a designated pattern. A user may time the duration required to climb the route and this time may be recorded and compared to that of other, geographically diverse climbers.

To obtain the standard items, the user 108 may, via the user node 106 and the server 100, purchase a kit 116. The kit 116 may include one or more standard items desirable for participation in the activity. The user 108 may purchase the kit 116 from an e-commerce module of the server 100, for example. The user 108 may purchase the kit 116 via the server 100, via the phone, via mail order, or the like. The user 108 may purchase the kit 116 from a retailer and/or local store.

In an embodiment, the kit 116 may include a WE 1911 Hi-Capa Semi-automatic blowback pistol, a magazine, a CED7000 Shot-Activated Timer, a container of Green Gas 1000 mL HFC 134a and/or HFC 22 Airsoft Gas, a container of BB's1000 or more, a pair and/or two of polycarbonate safety glasses, ten large airgun targets, ten small airgun targets, three courses-of-fire, a “quickstart” instruction card printed on heavy weight paper, an rulebook, a code of ethics, a website manual and/or login information, one or more target stands, one or more plans to build a target stand, scorecards, a membership card, and/or a carry box.

The user 108 may provide registration data 118 to the server 100. The registration data 118 may include biographical information such as name, address, age, etc. The registration data 118 may include gender, height, weight, area code, state, country, occupation, law enforcement, retired, military, school, fraternity, sanctioning body, or the like. The registration data 118 may include a username/password. The registration data 118 may establish a user account in connection with the server 100. Once the user 108 has registered with the server 100, the user 108 may receive at least one rule-set from the server 100.

The registration data 118 may include additional information to help limit competition with non-standard equipment. The registration data 118 may include a code physically associated with a proper standard item. For example, the standard airgun 110 from the kit 116 may have a serial number etched in the body of the airgun. The user 108 may be required to include this serial number as registration data 118. This optional feature may encourage use of standard equipment when participating in the real-life physical activity.

The registration data 118 may be stored at the server 100. The registration data 118 may be commercially leveraged. For example, the registration data 118 may be used for providing promotional opportunities to the users 108. The registration data 118 may be used to identify users 108 interested in related activities.

The user 108 may be classified into a division. The divisions may include “Advanced,” “Expert,” “Expert Optical,” and “Novice,” for example. Each division may have a common rule-set defining the nature of the division. For example, the different divisions may use different standard equipment such as more advanced air pistols, optical sights, laser sights, etc.

The server 100 may distribute a rule-set that defines the activity to all of the users 108 registered with the server 100. For example, the website may send course-of-fire data 120 to the users 108. The course-of-fire data 120 may specify the nature of the airgun shooting sport. The course-of-fire data 120 may be e-mailed to the user 108. The course-of-fire data 120 may specify the nature of the airgun shooting sport. For example, the course-of-fire data 120 may define aspects of the shooting sport. For example, the course-of-fire data 120 may include the placement of targets 112 and stands 114. The course-of-fire data 120 may specify an order and/or nature of a required shooting pattern, for example.

The user 108 may establish an activity area in conformance with the rule-set. For example, the user 108 may establish a personal range 122 in accordance with the rule-set. The rule-set may define a uniform standard for the personal range 112. The personal range 112 may be established in a number of locations indoors and/or outdoors. For example, the personal range 112 may be established in a basement, garage bay, backyard, enclosed porch, spare bedroom, workshop, shed, or the like. The personal range 112 for each user 108 may be geographically diverse from other users' personal ranges. For example, a first user 108 may establish a first personal range 112 in the basement of the first user's residence in a first city. A second user 108 may establish a second personal range 112 in the garage bay of the second user's residence in a second city. The system enables geographically diverse users 108 to participate in a real-life, physical activity and/or sport.

The personal range 112 may be a specified size. For example, the range may be eight-feet by 16 feet in area and seven-feet high. Personal ranges of other sizes are contemplated as well. The personal range 112 may define a target end and a shooter's end. At the target end, a pellet absorbing material such as a curtain, drop cloth, polyethylene sheeting, bed sheet, or the like may be placed behind the stands 114 and/or targets 112. The pellet absorbing material may act as a pellet trap. At the shooter's end, there may be defined a shooter's box. The shooter's box may be eight-feet by three-feet. The shooter's box may be divided into areas. The shooter's box may be divided into three areas. Each area may be designated by a different letter. The boundaries of the personal range 112 and the boundaries of the shooters box and the designated areas within the shooter's box may be defined by a suitable material such as tape, paint, or the like.

The user 108 may establish a personal range 122 in accordance with the course-of-fire data 120. For example, the user 108 may set up a standard target stands 114 from the kit 116 in accordance with the course-of-fire data 120. The user 108 may set up one or more targets 112 from the kit 116 in accordance with the course-of-fire data 120. For example, the targets 112 may be placed in specified positions on the target stands 114. The user 108 may measure a specified amount of distance between a shooting area and the target stands 114 and targets 112, for example.

The user 108 may record results associated with the participation in the real-life, physical activity. The user 108 may generate and/or record a metric. In an embodiment, the metric may be speed of fire and/or completion of the course-of-fire. For example, the user 108 may fire the standard airgun pistol 110 at the targets 112 in accordance with the course-of-fire data 120. The user 108 may generate a metric that corresponds with the elapsed time associated with completing the activity defined by the course-of-fire data 120. The user 108 may start a sound-operated timer that records an elapsed time for each firing of the airgun pistol 110. Once the user has engaged each target 112 and completed the course-of-fire data 120 the user 108 may record a metric corresponding with the total elapsed time from the beginning of the activity to the final fired pellet 111, for example. In an embodiment, the metric may be accuracy of fire. For example, the user 108 may fire at one or more targets, as defined by the course-of-fire data 120 and may count the number of shots required before completing the course-of-fire. The user may generate a hit-to-miss ratio indicative of the user's accuracy during the course-of-fire. The course-of-fire data 120 may direct the user to load a set number of pellets 111 into the airgun pistol 110. The user may generate an accuracy metric based on the number of targets knocked down using the set number of pellets. Other metrics may include, for example, time to reload, time to draw or pick-up gun and fire gun and/or hit target(s), etc. In an embodiment, the metric may include a combination of speed and accuracy associated with the course-of-fire.

The user 108 may submit results data 124 via the user node 106 in the network 104 to the server 100. For example, the user 108 may submit one or more metrics (i.e., elapsed time, score, hit/miss counts, hit/shots-fired ratio, reload time, etc.) associated with the registration data 118 to the server 100. The results data 124 may include scoring data from the user 108. The results data 124 from user 108 may be associated with the at least one metric. The server 100 may associate the results data 124 with the registration data 118 from the user 108. The metric received from the user 108 may be associated with the user 108's registration data 118 via the relational database and/or the datastore 102.

The server 100 may receive registration data 118 and results data 124 from more than one user 108. For example, multiple users 108 may compete in the real-life, physical activity. Multiple users 108 may each receive the same course-of-fire data 120 that defines a standard match. Once all the users 108 have completed the match within a pre-determined time period and in accordance with the course-of-fire data 120, users 108 may submit their results data 124. The users' data may be associated with the respective registration data 118. The server 100 may associate this data in the datastore 102.

The server 100 may process the received results data 124. The server 100 may generate ranking data 126 associated with the received results data 124 and registration data 118. For example, the ranking data 126 may order the results data 124. For example, the ranking data 126 may include an ordered list of the results data 124 from a best time to a worse time. For example, the shortest elapsed time associated with a match may be ranked first, and the longest elapsed time associated with a match may be ranked last. The ranking data 126 may include results data 124 representative of one or more metrics representative of performance, such as both precision and rapid-fire target shooting, for example.

The ranking data 126 may be associated with the registration data 118. For example, the ranking data 126 may be sorted by geographic locations such as city, state, country, or the like. The ranking data 126 may be sorted by other information present in the registration data 118. For example, the ranking data 126 may be sorted by age group, educational background, occupation, and/or a self-selected competition group such as amateur, professional, beginner, intermediate, expert, recreational, competitive, or the like. The ranking data 126 may be available via the server 100. For example, the ranking data 126 may be posted on a webpage accessible via the user node 106 in connection with the server 100. For example, the ranking data 126 may be distributed to users 108 via e-mail, postal mail, fax, or the like. For example, the ranking data 126 may be available via a dynamic query processing webpage. The dynamic query processing webpage may enable each user 108 to direct the server 100 to display the ranking data 126 in a format and order defined by the user 108.

In an embodiment, the ranking data 126 may be available to the users 108 at the same time. The results data 124 may be received from the users 108 over a designated period of time, and the results data 124 may remain in confidence at the server 100 until the end of the period of time. At the end of the designated period of time the associated ranking data 126 may be made available to the users 108. Postponing the publication of the ranking data 126 may encourage fair play and discourage cheating. Since users 108 may not have access to other scores until all the results data has been submitted, it will be more difficult for users 108 to intentionally enter a reasonable but false score that is better than the other scores.

The course-of-fire data 120 may be distributed as a competitive season. Once users 108 have completed the match associated with the first course-of-fire data 120, the users 108 may submit their results data 124 to the server 100. The server 100 may distribute a second course-of-fire data 120 associated with a second match. Users 108 may complete the second match and may submit their second results data 124 to the server 100.

For example, the server 100 may distribute course-of-fire data 120 that is associated with a match. For example, once a week, three courses-of-fire data may be e-mailed to participants and/or presented on the website. Courses-of-fire data may become available at 0001 GMT Sunday in a given week. Users 108 may be provided a specified set of time to submit three timed shooting scores for each of the three courses of fire. Scores may be uploaded to the website for the previous week up until the time the next set of course-of-fires are issued. Shooters may upload their best times for each of three courses of fire for that week. Once a member uploads his score, overriding the scores may be disabled. Once a week has concluded, scores for other members in the same shooting week may be released and may be associated with the ranking data 126.

The server 100 may iterate distributing courses-of-fire data and receiving results data 124 as defined in the season. The season may last for a predetermined duration of time, for example, 12 weeks, for a total of 36 courses of fire. In this example, three seasons may be provided via the server 100 every year. The participant may practice the course of fire and may designate three attempts as non-practice, scored attempts. The two best scores for each user 108 for each course-of-fire may be used made official. The third score may be used to settle ties between users 108. Users 108 starting mid-season may be given a ranking equal to the worst scoring users 108 participating in the season. If a user 108 fails to submit a score in a week, the user 108 may be given a score equal to the worst score submitted that week.

The ranking data 126 may sort according to individual match and/or an overall season performance. In one embodiment, the top 100 shooters from a season may be invited to participate in a championship shoot-off. The championship shoot-off may include geographically diverse competition. The championship shoot-off may include additional courses-of-fire and/or co-located competition.

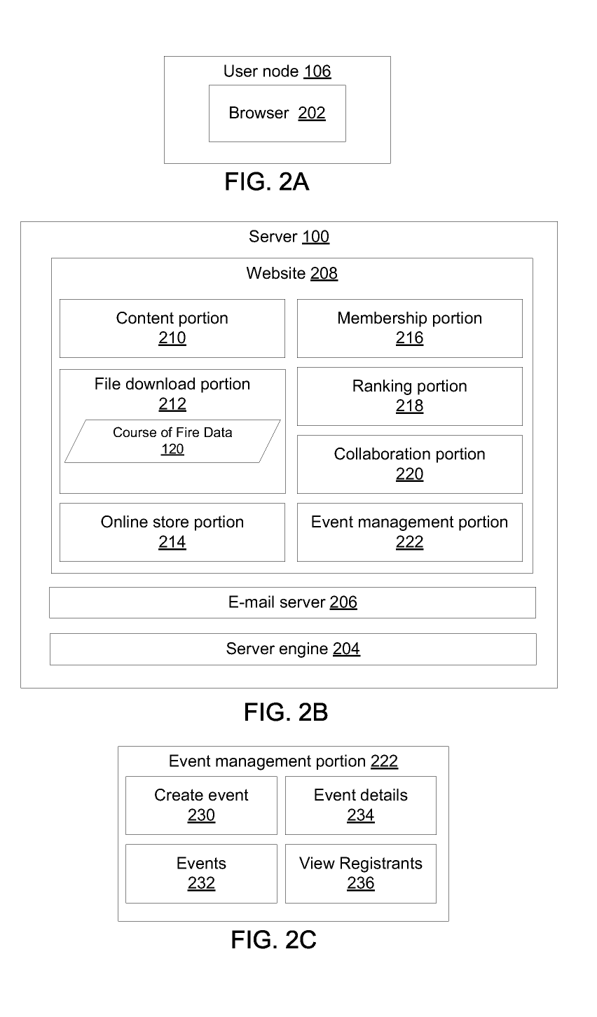

FIGS. 2A & 2B depict a user node 106 and server 100, respectively, for use in an example system for distributing game information and processing game results. Referring to FIG. 2A, the user node 106 may include a browser 202. The browser 202 may include any software suitable for providing communication with the server 100. For example, the browser 202 may be an Internet browser. The browser may be suitable for communicating via HTTP. The browser 202 may be suitable for displaying information and submitting information via webpages.

Referring to FIG. 2B, the server 100 may include a server engine 204, an e-mail server 206, and/or a website 208. The server engine 204 may include an operating system, operating environment, virtual machine, or the like. The server engine 204 may provide a platform upon which the website 208 may operate. The server engine 204 may provide technical functionality enabling the website 208 to communicate with the network. For example, the server engine 204 may include device drivers associated with the network.

The e-mail server 206 may include any software suitable for sending and/or receiving e-mail. For example, the e-mail server 206 may be an Simple Mail Transfer Protocol (SMTP) server. The e-mail server 206 may communicate with users via a respective e-mail address associated with each user in the registration data. The course-of-fire data, updates, news, promotions, results data, or the like may be e-mailed to the users via the e-mail server 206.

The website 208 may include a content data and/or executable data. The content data may include information related to the real-life, physical activity. For example, the content data may include Hypertext Markup Language (HTML) encoded information. The content data may include text, audio, images, video, and the like. The executable data may provide interactive and/or dynamic features of the website. For example, the executable data may include Active Server Pages, Common Gateway Interface (CGI) applications, Perl scripts, or the like. The executable data may provide processing of data, receipt of data from users, and/or sorting of data from the datastore. The executable data may provide an interface with the datastore.

The website 208 may provide a plurality of portions. Each portion may be accessible to the user. For example, the website 208 may include a content portion 210, a file download portion 212, an online-store portion 214, a membership portion 216, a rankings portion 218, a collaboration portion 220, and/or a event management portion 222.

The content portion of the website 208 may include information associated with the seasons, matches, real-life activity, shooting sport, or the like. The content portion 210 may include webpages such as a homepage, a news page, a club page, a schedule page, or the like.

The online-store portion 214 may include functionality for displaying and/or selling kits and/or one or more standard items associated with real-life, physical activity. For example, the online-store portion 214 may offer kits containing airgun targets and target stands. The online-store portion 214 may include additional items ancillary to participation in the activity such as T-shirts, apparel, novelty items, or the like. The online-store portion 214 may sell consumable standard items. For example, airgun targets and target stands may become worn after repeated use. Users may wish to purchase replacement targets and target stands. The online-store portion 214 may sell such replacement targets and target stands.

The membership portion 216 may include functionality and data associated with membership and/or registration. For example, users may sign in and/or login to the website via the membership portion 216. The users may update registration data via the membership portion 216.

The rankings portion 218 may include data and/or functionality associated with ranking and presenting the results data received from users. For example, the rankings portion 218 may include a sorted list. The ranking portion may include data controls such that the users may select categories and/or search criteria by which the results data may be sorted and/or displayed. For example, the rankings portion 218 may include functionality to provide dynamic queries associated with a particular user. For example, a user may wish to see how he or she ranks in relation to other users in a similar age group, with a different occupation, in a different competition group, etc. A user may wish to see his or her overall ranking. The user may wish to see for a given season and/or match the performance required in order to improve his or her ranking.

The collaboration portion 220 may include data and/or functionality associated with collaborative and/or social networking. For example, the collaboration portion 220 may define user web-space such that users may post comments, photographs, and/or audio/visual media associated with their participation in the real-life physical activity. For example, users may post video of the performance in a given match with a particular course-of-fire. The collaboration portion 220 may enable user forums, web-based virtual groups, teams, recreational online clubs, and the like.

In an embodiment, the rankings portion 218 may sort the results data according to data associated with the collaboration portion 220. For example, a plurality of users may establish a virtual club via the collaboration portion 220. The scores associated with the plurality of users from the rankings portion 218 may be averaged to provide an overall club score associated with the virtual club. A plurality of clubs may define a plurality of scores, and the clubs may compete against each other.

The file download portion 212 may include the functionality and/or data associated with providing information to users. For example, the course-of-fire data 120 may be available via the file download portion 212. Also for example, the file download portion 212 may include rules and regulations documents, newsletters, video clips, promotional media, specialty and exhibition courses-of-fire, or the like.

The event management portion 222 may include functionality and/or data associated with creating, managing, and deleting one or more events. For example, each event may represent a course-of-fire match. The event management portion may enable a process of automated registration for events as well as provide the administrative functionality for managing events. The event management portion may provide an interface to create, edit, and delete details about individual matches, seasons, competitions, championship events, and the like.

As shown in FIG. 2C, the event management portion may include one or more pages. Each page may provide a designated functionality.

At the create event page 230, an Administrator may be able to initiate a new event by filling out a form with information. Once a new event has been saved it appears in the event summary data. Once a saved event is designated active by the administrator it becomes eligible for member registration. The create event page 230 may be used to edit an existing event and save it as a new event. When editing an existing event, the form presented on the create event page 230 may be pre-populated with saved information.

At the events page 232, the user may be presented with a summary listing of all active and inactive events. The listed events may be visually grouped as “upcoming” and “recent events.” The upcoming events may be presented in ascending order from the current date. The recent events may be listed in descending order from the current date. Administrators can see events in greater detail; create, edit, delete, and/or view registrants for an event; and export registrant data directly from this page. The export feature may export a listing of registrant data to an XML file. The XML file may facilitate migration to a database for storage, publication, and/or attendance management.

The event details page 234 may provide a display of information associated with an individual event. The data-set for an event may include a title, description, location, time, date, cost, whether the event is accepting registrations, and the like.

From the view registrants page 236 an administrator can list the registrants for an individual event. Each member name may be hyperlinked to the user's account. The page would provide functionality to add and remove registrants in association with an event. The view registrants page 236 may link to a listing of current and previous events associated with an individual member. In an embodiment, the adding and removing of registrants from an event may trigger an automated email notifying registrants that such action has occurred. The view registrants page 236 may include a export function that generates an XML formatted file containing registrant data. For example, the XML file may include a summary of registrant data for a designated event.

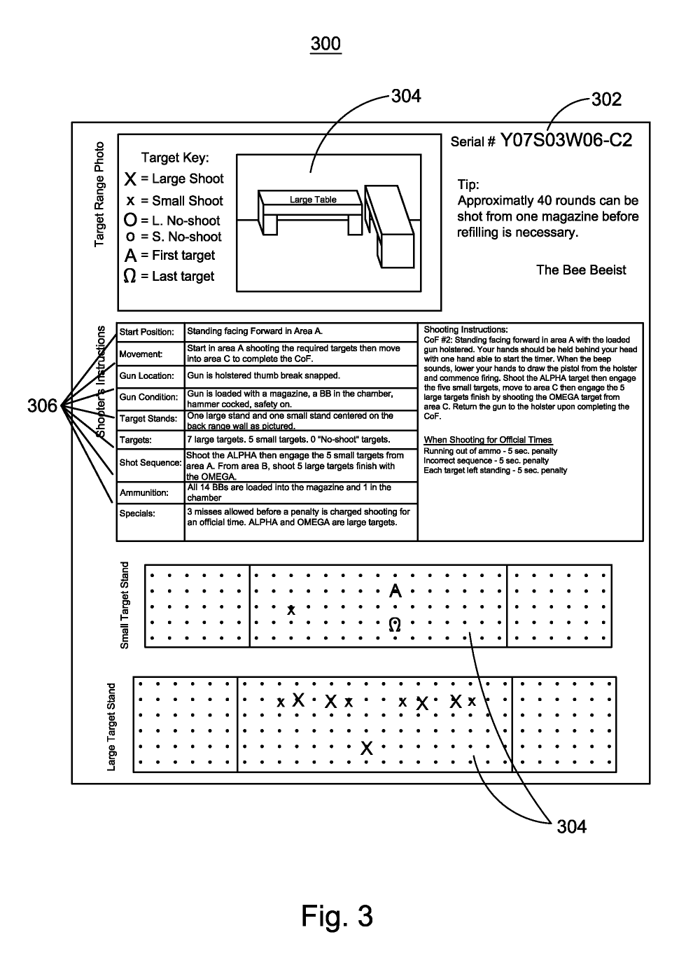

FIG. 3 depicts an exemplary course-of-fire document 300. The course-of-fire data may be provided by a course-of-fire document 300. The course-of-fire document 300 may be an electronic document such as a webpage, e-mail, word processing document, portable document format document (PDF), or the like. The course-of-fire document 300 may specify shooting conditions that must be followed for a particular match. The course-of-fire document 300 may establish a particular setup up of the personal range.

The course-of-fire document 300 may include a course-of-fire serial number 302. The unique serial number may indicate year, season, week, etc. For example, the first course of the fourth week of the second season in the year 2007 may have a course-of-fire serial number of 07S02W04-C1.

Course-of-document may include a one or more graphical representations 304 of the personal range. The graphical representations 304 may include instructions associated with the relative position of the targets and the target stands in relation to the personal range. The graphical representation 304 may be a three-dimensional rendered drawing or photograph illustrating the orientation of the target stands. The graphical representation 304 may be a two-dimensional figure illustrating the placement, order, and sequence of engagement associated with the knock-down targets.

The course-of-fire document 300 may include setup information 306 that specifies shooting order and/or shooting conditions. For example, the course-of-fire document 300 may specify shooting position, shooting location, shooter movement, gun location, target location, target shooting sequence, the areas within which to stand when shooting targets, the levels on which the targets are set, the elevation, barricades, silhouettes, and/or lighting effects, and the like.

The course-of-fire document 300 may specify the actual position of the shooter. For example, the shooter may be standing, sitting, etc. The course-of-fire document 300 may specify which area of the shooter's box the shooter may start. The course-of-fire document 300 may require the shooter to move from one area to another area. The course-of-fire document 300 may specify any movement involved during the course of fire activity. For example, the shooter may start in a first position, shoot a designated number of targets, and then move to a second position. The course-of-fire document 300 may specify a starting position for the airgun. For example, the airgun may be held in the shooters strong shooting hand, safety on, ready to fire held at the side in a relaxed position, in a holster, or the like.

The course-of-fire document 300 may specify the number, size, and/or position of targets to be used. There may be instructions about the number of shoot and “no-shoot” decoy targets. The course-of-fire document 300 may use symbols representative of large targets, small targets and no-shoot targets. The symbols may be used in the graphic representation of the shooting range. The course-of-fire document 300 may include graphic instructions showing the placement of targets and the correct size target to use in the specified location in relation to the one or more target stands. The graphic instructions may depict the position and/or orientation of the one or more target stands. The course-of-fire document 300 may specify the use of silhouettes. Patterns for silhouettes may be included the course-of-fire document 300. The silhouettes may be made of foam core, poster board, cardboard, cardboard box, or the like. Stands for the silhouettes may be made from the same material as the silhouette itself.

The course-of-fire document 300 may specify other conditions of the personal range. For example, the course-of-fire document 300 may specify the use of a barricade. Barricades may be made of insulation foam, foam core material, sturdy cardboard, or the like. The course-of-fire document 300 may specify lighting effects. For example, the course-of-fire document 300 may direct the user to hold a small flashlight. For example, the course-of-fire document 300 may designate a position relative to the targets and stands for a single point light source such as a work lamp.

The course-of-fire document 300 may include a space for the user to record her or her elapsed times to complete the course-of-fire.

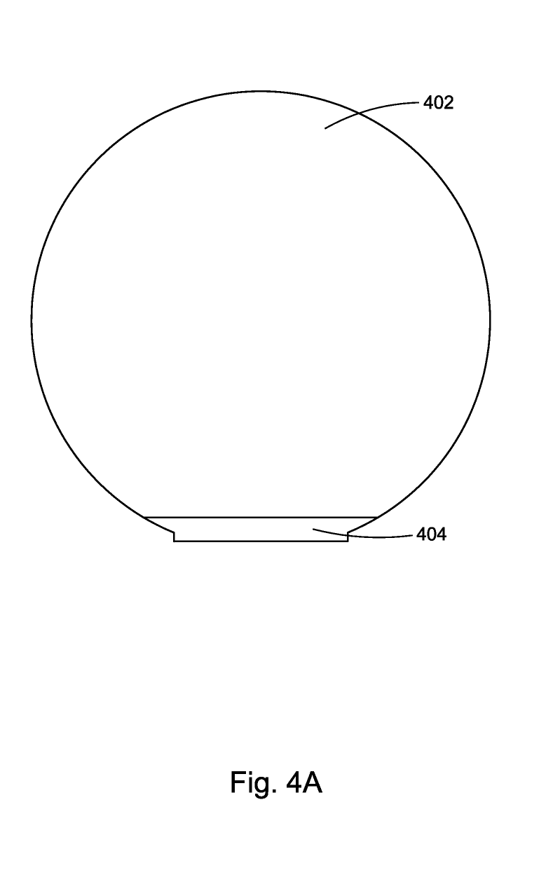

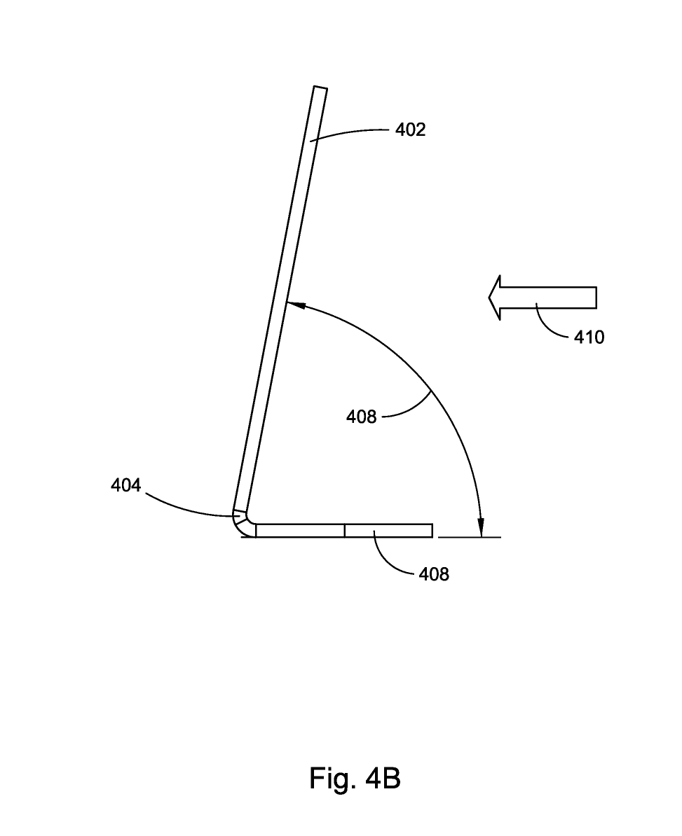

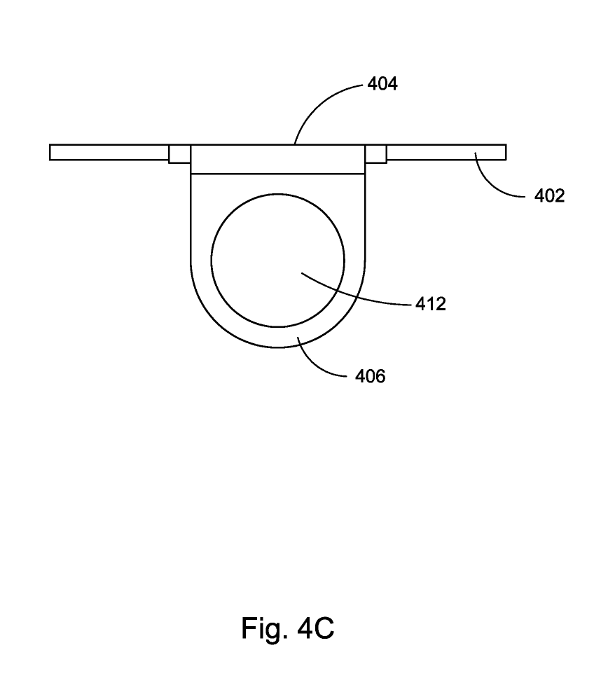

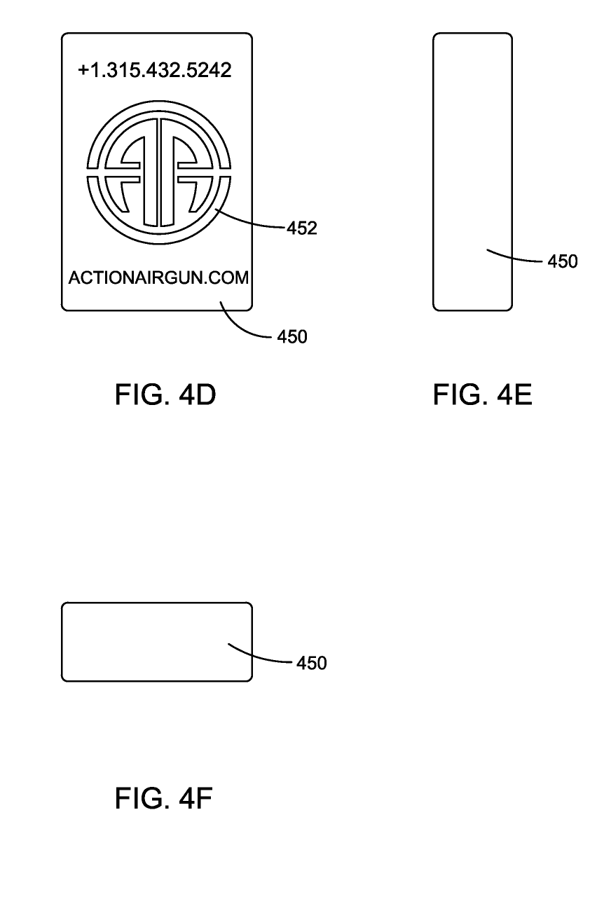

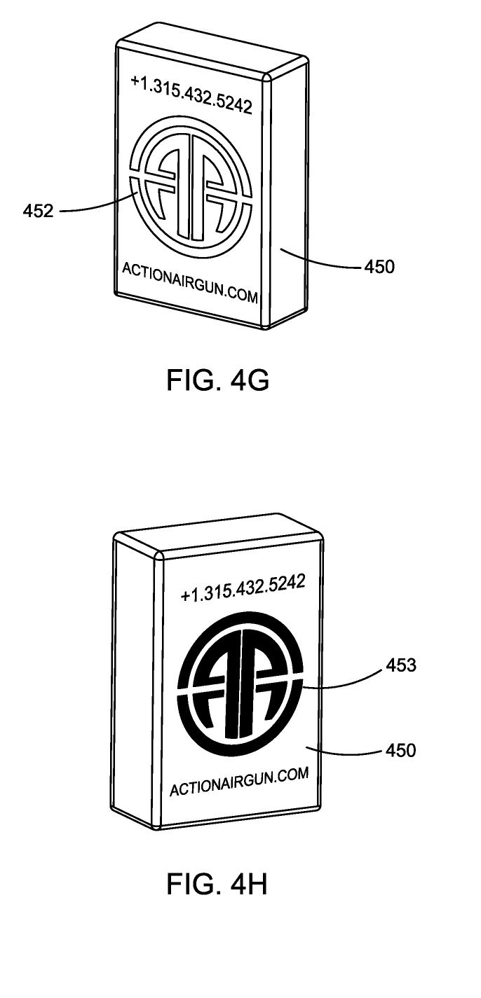

FIGS. 4A-C depict an example airgun target in front, side, and bottom views respectively. The airgun target may include a striking portion 402, a vertex portion 404, and/or a base portion 406. Striking portion 402 may define a first plane. The striking portion 402 may be any shape suitable for receiving incoming airgun pellet. For example, the striking portion 402 may be circular. The striking portion 402 may be any size suitable for target shooting. For example, the striking portion 402 may be substantially circular with a three-inch diameter. For example, the striking portion 402 may be substantially circular with a two-inch diameter. For example, the striking portion 402 may be substantially circular with a one-inch diameter.

The vertex portion 404 may provide a flat edge to the substantially circular striking portion 402. For example, the vertex portion 404 may be connected to an edge of the striking portion 402. The edge of the string portion maybe a flat edge. For example, the vertex portion 404 may define a chord between two points along the circumference of the striking portion 402. The vertex portion 404 may connect the base portion 406 to the striking portion 402.

The vertex portion 404 may include a bendable portion. For example, the target may be formed as a flat, a single unit, such that the striking portion 402 defines a first plane and the base portion 406 defines a second plane coplanar with the first plane. For example, the flat position may be desirable when manufacturing, shipping, and/or storing the target. The airgun target may be bent along the vertex portion 404 providing angle 408 between the first plane defined by the striking portion 402 and the second plane defined by the base portion 406.

The target may be bent such that the target is supported by the base portion 406. For example, the striking portion 402 may be supported by the base portion 406. For example, the target may be bent such that the first plane defined by the striking portion 402 intersects the second plane defined by the base portion 406 at an angle 408. The angle 408 may be substantially 80°. The angle 408 may be any suitable angle 408 such that the airgun target may stand freely on the base portion 406, and the base portion 406 supports the striking portion 402. The target may define an acute interior angle 408 from the striking portion 402 to the base portion 406.

The target may be positioned such that is leans in the direction of the shooter. In FIG. 4B, the direction of the pellet may be represented by an arrow 410. The pellet may strike the surface of the striking portion 402 may be deflected downward away from the shooter. The angle 408 between the striking portion 402 and the base portion 406 may provide additional safety.

The airgun target may be made of a bendable material. The airgun target may be made of a material durable for repeated impacts from airgun pellets. The airgun target may be made of aluminum. For example, the airgun target may be made of a 3003 aluminum alloy. For example, the airgun target may be made of 0.05 inch aluminum sheet. For example, the target may be stamped from the aluminum sheet. The target may be machined from the aluminum sheet.

The target may be made of a suitable material and designed such that an incoming airgun pellet may topple the target. The “knock-down” target may enhance the action of the shooting sport. The toppling action may enhance the overall shooting experience by emulating the dramatic impact of conventional firearms. The toppling action may increase the reusability of the targets because the known down action may absorb energy transferred from the pellet.

The force applied from a typical airgun pellet fired at a distance properly defined by the personal range may cause the striking portion 402 to tip backwards, rotating the target until the base portion 406 no longer supports the target. At that point, the target topples. To illustrate, a typically airgun pellet may weigh about 0.2 grams. When fired from a recreational airgun, like the one used in an airgun shooting sport, the pellet may travel about 290 feet per second. The momentum from the traveling pellet may be sufficient to topple a two-inch target weighing about 20 grams and/or a three-inch target weighing about 46 grams.

Referring to FIG. 4C, in an embodiment, the target may have additional material removed from the base portion 406 defining a void 412 through the base portion 406. The void 412 in the base portion 406 may lower the overall weight of the target while maintaining structure to support the striking portion 402. The removed material and resulting lessened weight may make the airgun target topple with more speed and force when struck by the airgun pellet. Such a more forceful toppling may increase the effect of striking the target and the enjoyment associated with the shooting sport. For example, the user may fire an airgun pellet, hit a target, and enjoy the distance and velocity at which the airgun target topples. As shown, the void 412 may be substantially circular.

The base portion 406 may be sized in proportion to the striking portion 402. For example, a striking portion 402 having a three-inch diameter may correspond to a base portion 406 approximately one-inch by one-inch. The void 412 in such a base portion 406 may have a diameter of about 0.8 inches. A target having a striking portion 402 with a three-inch diameter may weigh about 46 grams if made of steel. A target having a striking portion 402 with a three-inch diameter may weigh about 22 grams if made of aluminum. The ratio of striking portion weight to base portion weight in the three-inch target may be about twenty-to-one.

In another embodiment, a striking portion 402 having a two-inch diameter may correspond to a base portion 406 that is approximately 0.75 inches by 0.75 inches. The void 412 in such as base portion 406 may be about 0.6 inches in diameter. A target having a striking portion 402 with a two-inch diameter may weigh about 20 grams when made of steel. A target having a striking portion 402 with a three-inch diameter may weigh about 8 grams when made of aluminum. The ratio of striking portion weight to base portion weight in the two-inch target may be about ten-to-one.

FIGS. 4D-H depict an example airgun target 450, in front, side, bottom, front perspective, and rear perspective views, respectively. The airgun target 450 may be made of dense foam material, such as soft closed-cell foam that has been sealed and coated or foam rubber. For example, the airgun target 450 may be made of foam polyurethane. The specific gravity of material may be about 1.05-1.26.

In use, an incoming pellet at typical airgun velocities bounces off of the surface of the target and topples the target. The pellet loses enough energy in exchange that it falls harmlessly to the ground. The target's density prevents the pellet from penetrating the foam target or excessively deteriorating the surface; thus, the target, in the context of airgun action sports, is reusable.

The target may be any size suitable for airgun action sports. For example, the target may be about 2″×3″×1″ in size. The target may weight between about 0.5 oz and 6 oz.

The target may be self-skinning foam or dipped to provide a surface suitable for screen printing. In an embodiment, two sides of the target may include respective indications 452, 453 that the target is a “no-shoot” or a “shoot” target in the defined arrangement of targets. For example, a “no-shoot” side indication 452 may have a logo, colors, or other marketing to indicate that it is a “no-shoot” side. For example, the “shoot” side may have a red logo. Similarly, a “shoot” side indication 453 may have a logo, colors, or other marketing to indicate that it is a “shoot” side. For example, the “shoot” side may have a green logo. In practice, a target with its “no shoot” side facing the player may be placed to partially overlap with a target with its “shoot” side facing the player to make the effective target area smaller.

Thus, in the context of an system for enabling a real-life, physical activity for a plurality of geographically diverse participants, a rule-set (e.g., course of fire document) may indicate the placement of one or more airgun targets and may indicate their respective “shoot” or “no shoot” designations. Then, the user may position the airgun targets 450 such that the face of the target corresponds with the designation in the rule-set.

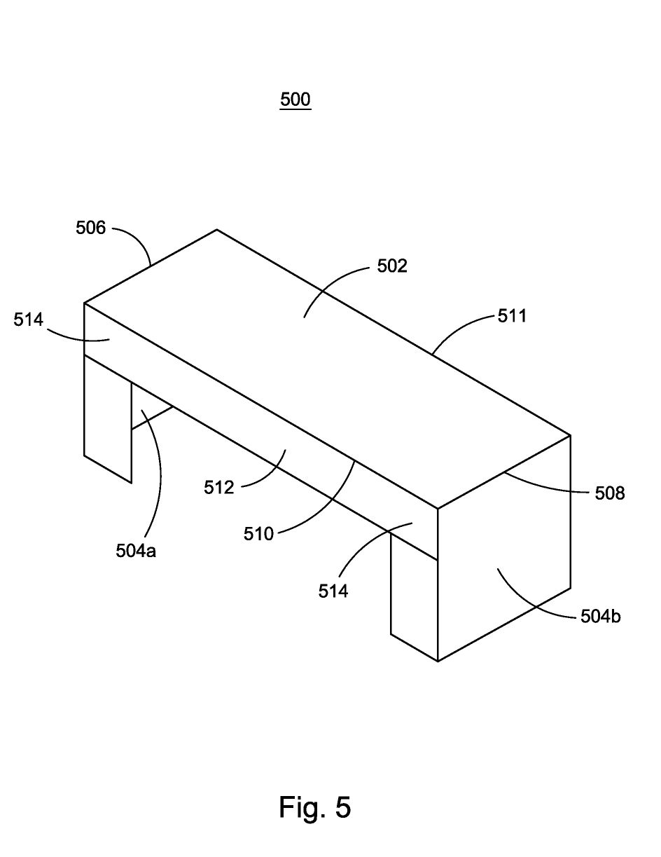

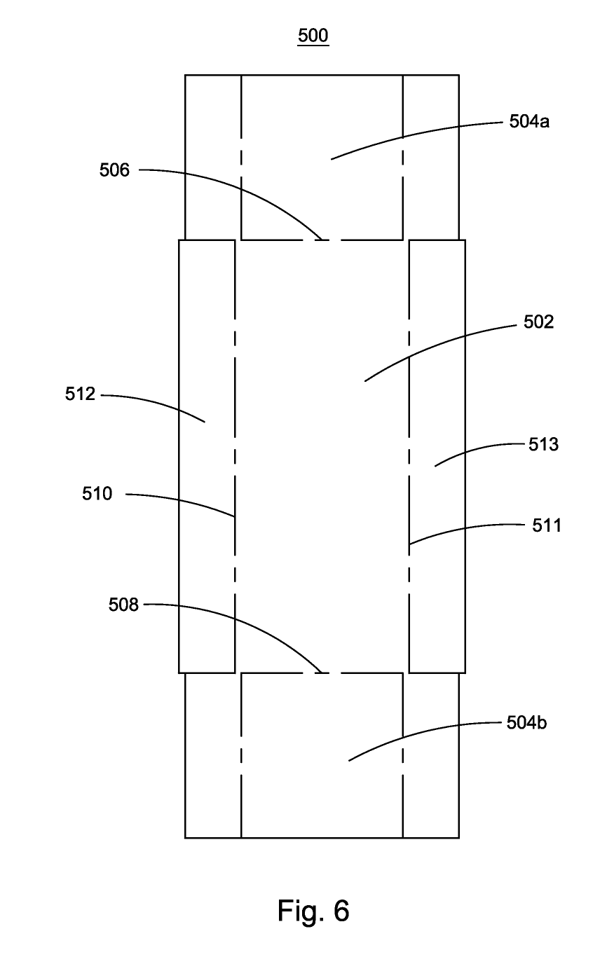

FIG. 5 depicts an exemplary target stand 500, assembled, in isometric view, and FIG. 6 depicts the exemplary target stand 500, unassembled, in a top view. The target stand 500 may be made of a material suitable for supporting airgun targets and safely receiving errant shots. For example, the target stand 500 may be made of cardboard. The cardboard may be corrugated cardboard, for example.

The target stand 500 may be folded into an assembled position, as shown in FIG. 5, or the target stand may be laid into a flat position in FIG. 6. In the assembled position, the target stand 500 may support targets in the participation of a shooting sport. In the flat position, the target stand 500 may be more suitable for storage and/or shipping.

The target stand 500 may define a table portion 502 and one or more leg portions 504a-b. The table portion 502 may be supported by the leg portions 504a-b. For example, the table portion 502 may define a first edge 506, a second edge 508, a third edge 510, and a fourth edge 511. The second edge 508 may be opposite the first edge 506. The third edge 510 may be between the first edge 506 and the second edge 506. The fourth edge 511 may be between the first edge 506 and the second edge 506. The fourth edge 511 may be opposite the third edge 510. The stand 500 may define a first leg portion 504a. The first leg portion 504a may be connected to the first edge 506. The stand 500 may define a second leg portion 504b. The second leg portion 504b may be connected to the second edge 506. The stand 500 may define a first flap portion 512. The first flap portion 512 may be connected to the third edge 510. The stand 500 may define a second flap portion 513. The second flap portion 513 may be connected to the fourth edge 511.

The table portion 502 may be substantially rectangular. The table portion 502 may have a length of about 48 inches and a width of about 18 inches. Each flap portion 512 may have a length of about 48 inches and a width of about 6 inches. Each leg portion 504a-b may be about 18 inches high. Larger and/or smaller target stands are contemplated to provide additional variability in the shooting sport.

In the assembled position, illustrated in FIG. 5, the first flap portion 512 may be demountably engaged to the first leg portion 504a and the second leg portion 504b. In the assembled position, the second flap portion 513 may be demountably engaged to the first leg portion 504a and the second leg portion 504b. The target stand may include one or more fasteners 514. The fasteners 514 may provide additional structural support. The fasteners 514 may be rivets, for example. In the assembled position, at least one of the first leg portion 504a and the second leg portion 504b may support table portion 502. For example stand may be may rest on both the first leg portion 504a of the second leg portion 504b as shown in FIG. 5. Also for example, in the assembled position, the stand may be oriented on its side. For example, the first leg portion 504a may be supported by the second leg portion 504b and the table portion 502.

The fasteners 514 may be removed and the first leg portion 504a, second leg portion 504b, and/or flap portion may be positioned coplanar with the table portion 502, as shown in FIG. 6. In this flat position the target stand may be more suited for shipping and/or storage.

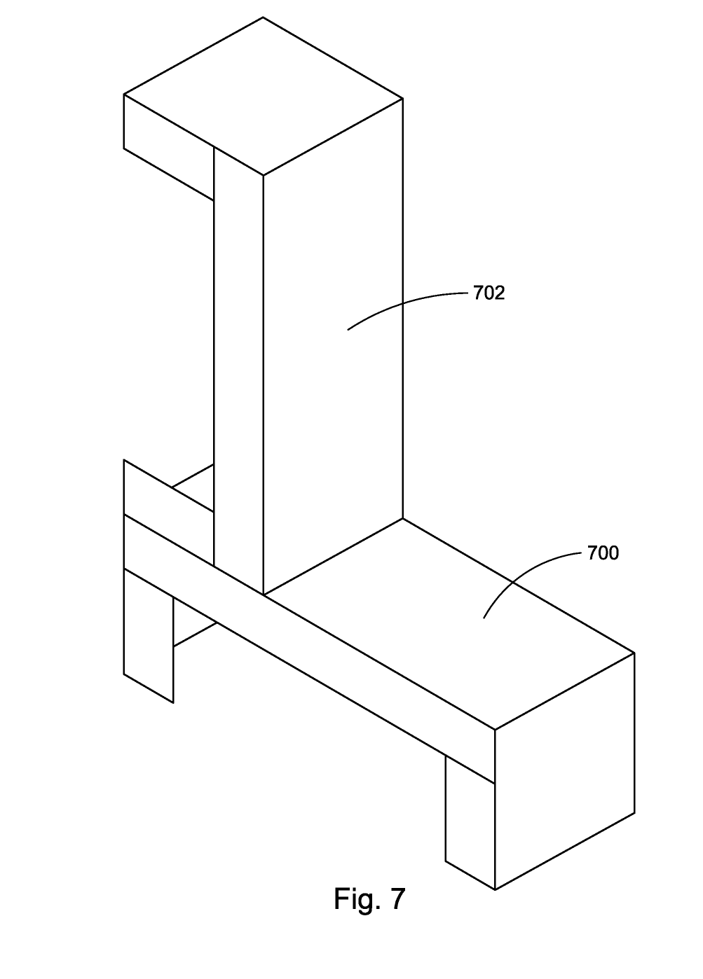

One or more target stands 500 may be provided to a user in a kit. The one or more target stands 500 may be stacked and/or oriented in a plurality of ways. For example, the target stands 500 may be oriented side-by-side, stacked one on top of the other, rotated relative to one another, or the like. For example, FIG. 7 shows an exemplary orientation were a first target stand 700 may be positioned on the floor of the personal range such that the table portion is purported supported by the two leg portions. A second target stand 702 may be placed on the first target stand 700 and oriented on one side such that the leg portion of second stand becomes parallel to the table portion of the first stand. In such an orientation, the user may place targets on the table portion of the first target stand 700 and/or the upper leg portion of the second target stand 702. Thus, the target stands provide variability and variety of positions and orientations. Each position and orientation may be defined via the course-of-fire document.

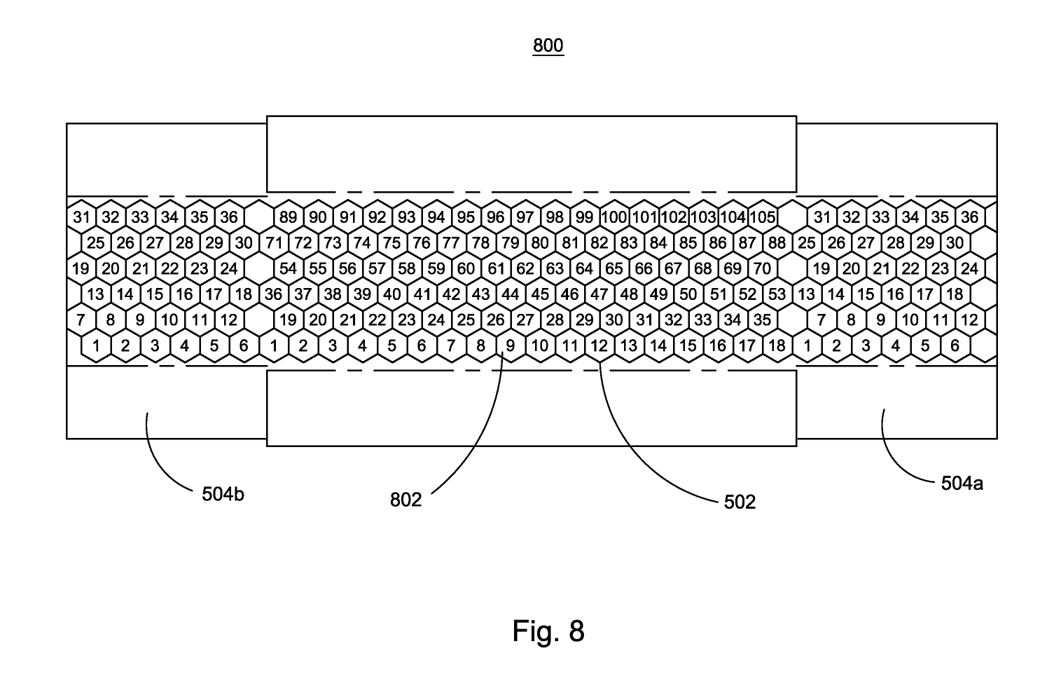

FIG. 8 depicts an example target stand, unassembled, in a top view with an example target placement grid 800. The target stand may include target location information. The target location information may include a identifiable cross-reference and/or index value referenced in the course-of-fire document.

For example, the target stand may include a plurality of identified cells 802 printed on the table portion 502. The plurality of identified cells 802 may be identified by a respective number and/or code. For example, table portion 502 may include hexagonal cells. The cells may be any shape, such as square, rectangular, circular, hexagonal or the like. For example, the table portion 502 may include any number of cells. As shown, the table portion 502 may include 125 hexagonal cells. The hexagonal cells may be arranged adjacent to one another in rows. For example, the hexagonal cells may be arranged and staggered in rows such that adjacent cells abut one another sharing at least one common side. For example, the table portion 502 may include three rows of 18 hexagonal cells interleaved with three rows of 17 hexagonal cells. The leg portions 504a-b may include a plurality of identified cells 802 as well. As shown, the leg portions 504a-b may each include sex rows of six hexagonal cells.

At least one of the plurality of individually identified cells may be identified in the course-of-fire document. The course-of-fire document may specify the placement of the targets on the target stand by referencing one or more of the individually identified cells. FIG. 3 illustrates another example of a target placement grid (see e.g., graphical representation 304).

The target stands may be provided in a kit. The kit may include at least one stand and an instruction for its arrangement. For example instructions may provide directions identifying the assembled position and the flat position. The instructions may provide direction about assembling and dismantling the target stands, for example.

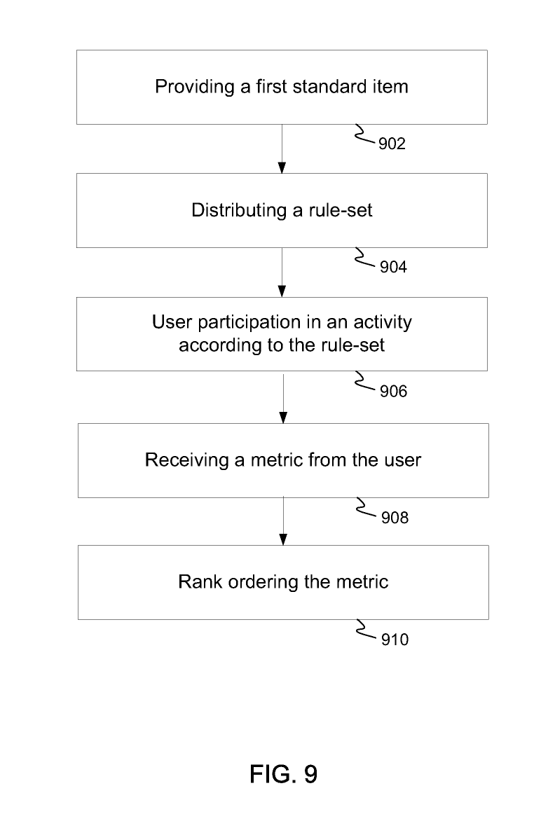

FIG. 9 depicts a flowchart of an example process for organizing and implementing a distributed shooting sport. At 902, a first standard item may be provided. The first standard item may be provided in response to receiving a request at the server of the standard item. The first standard item may be provided to a user for participation in a real-life, physical activity. The real life activity may include any activity that requires a physical interaction with a tangible object. The real-life, physical activity may include a shooting sport, such as an airgun shooting sport. The first standard item may include a standard airgun, a standard target, a standard target stand, a standard airgun shot timer, or the like. The first standard item may be provided as part of a kit. For example, the first standard item may be sold to the user. For example, the first standard item may be sold via a website.

At 904, a rule-set may be distributed. The rule-set may be distributed in response to a request at the server for the rule-set. The rule-set may define the real-life, physical activity. The rule-set may require the first standard item for participation in the real-life, physical activity. The rule-set may be distributed to a plurality of remote and/or geographically diverse users. The rule-set may be distributed by e-mail. The rule-set may be downloadable from a website. The rule-set may include a course-of-fire document.

At 906, the user may participate in the activity according to the rule-set. For example, the user may set up a target and/or a target stand in accordance with the course-of-fire document. The user may generate a metric. The metric may be associated with the course-of-fire document. For example, a metric may include a measure of accuracy, speed, efficiency, and or the like. The user may time the duration associated with completing the match as defined by the course-of-fire document. The user may record at least one elapsed time associated with the match. The user may submit the metric to the website.

At 908, the website may receive the metric from the user. At 910, the website may rank order the received metric. The website may provide the rank ordering to the users.

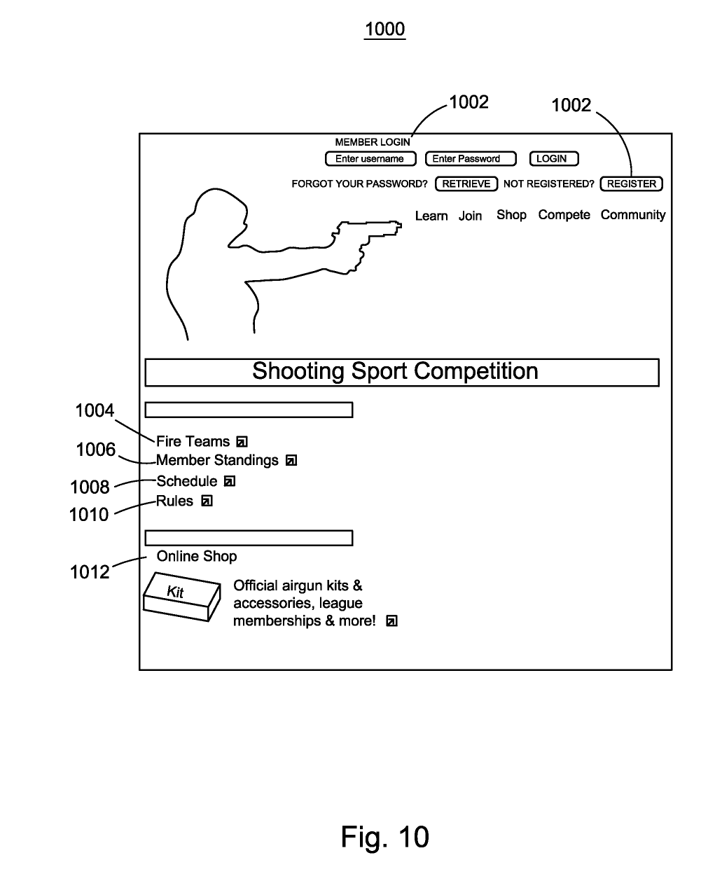

FIG. 10 depicts an example webpage 1000 for distributing game information and processing game results. The webpage 1000 may be distributed to the user via the server (as shown in FIGS. 1 & 2). The webpage may include one or more hyperlinks to other pages and/or features of the website. The webpage 1000 may include a member login link 1002. The member login link 1002 may enable a user to enter identification credentials to access other linked pages. The webpage 1000 may include a registration link 1002. The registration link 1002 may enable people to associate with the website 1000 by becoming a member. The registration link 1002 may enable users to send registration data to the server.

The webpage 1000 may include a fire teams link 1004 that enables a collaborative team and/or virtual club aspect of the server. The webpage 1000 may include a member standings link 1006. The member standings link 1006 may enable users to view and/or filter rankings data. The webpage 1000 may include a schedule link 1008. The schedule link 1008 may present a list of competition seasons and/or the pertinent dates associated with the seasons. The webpage 1000 may include a rules link 1010. The rules link 1010 may provide a rule-set to the user. The rules link may direct the user to competition rules and safety rules. The rules link 1010 may direct a user to course-of-fire data.

The webpage 1000 may include an online shop link 1012. The online shop link 1012 may direct a user to an e-commerce component of the website. The online shop link 1012 may enable the user to purchase standard items required by the rules to participate in the real-life, physical activity. The online shop link 1012 may enable the user to purchase a kit to participate in a shooting sport, for example.

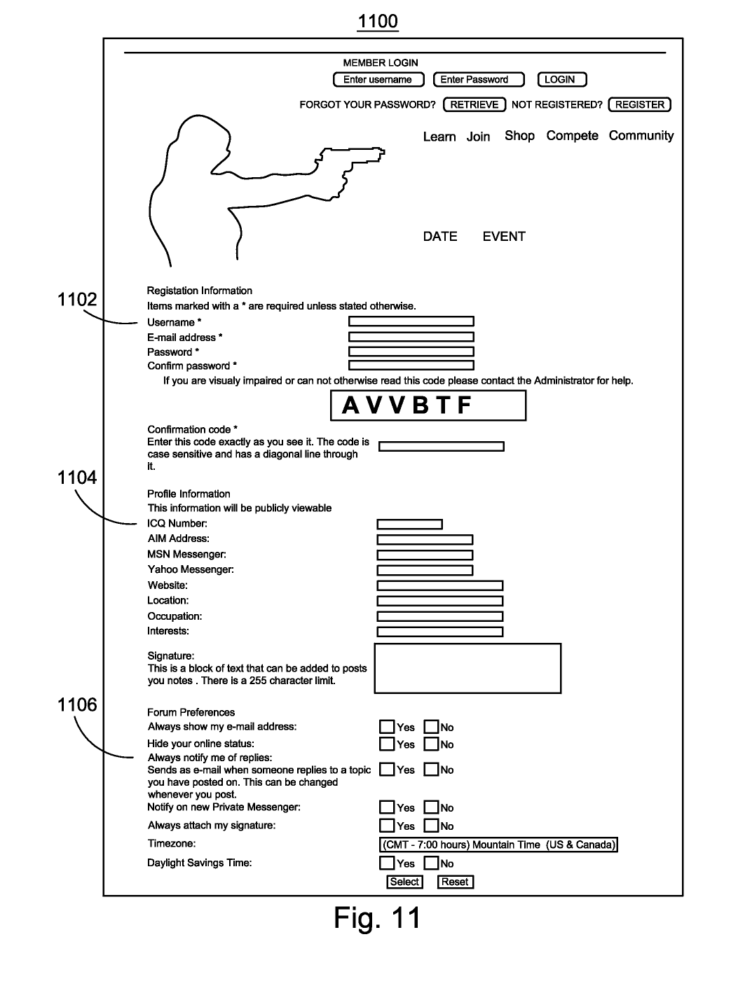

FIG. 11 depicts an example registration webpage 1100. The registration webpage 1100 may enable participants to associate themselves with the shooting sport. The registration webpage 1100 may receive from the user identification information 1002, profile information 1104, and forum preferences 1106. The identification information 1002 may include a username and a password. The profile information 1104 may include background details about the participant such as occupation, location, interests, clubs, organizations, etc. The forum preferences 1106 may include attributes of the participant's presence via the website, such as showing/hiding the participant's e-mail address, showing/hiding online status, time zone information, etc.

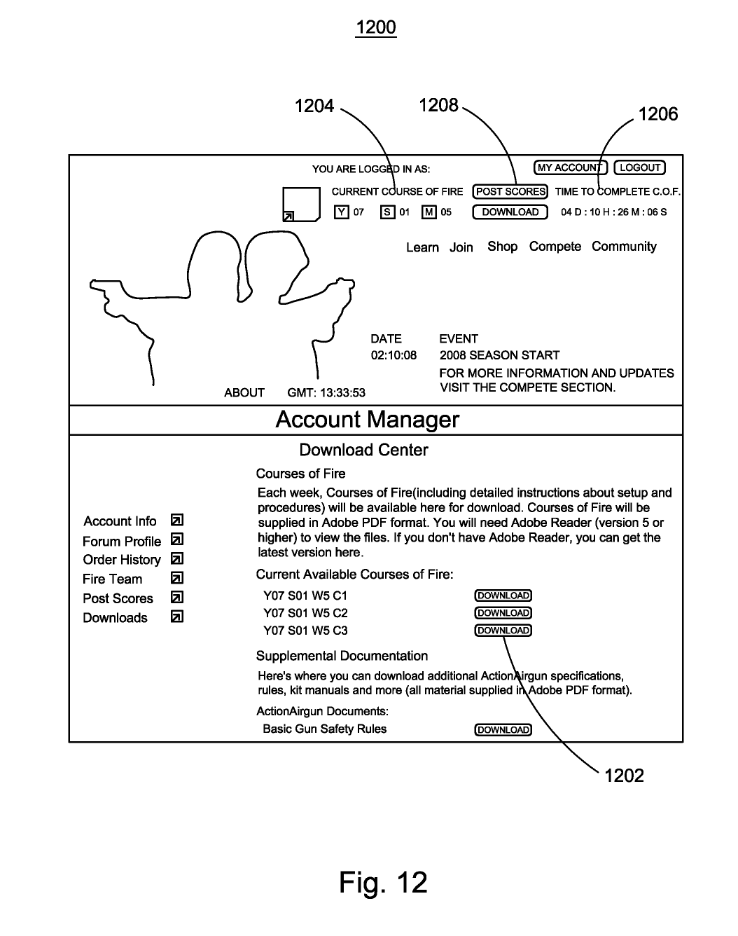

FIG. 12 depicts an example download center webpage 1200 from which the course-of-fire may be distributed. The download center webpage 1200 may enable users to download one or more course-of-fire documents and/or additional information. The user may click on a download button 1202 to access the currently available course-of-fire documents. For example, the courses-of-fire may be downloaded in portable document format (PDF) files. In addition, the user may download supplemental documentation such as gun safety rules, specifications, user manuals, and the like.

The download center webpage may include a currently pending course-of-fire display 1204 that shows which course-of-fire is currently being played. The download center webpage may display a time counter 1206 showing the time left to complete the current course-of-fire. The download center webpage may include a post scores button 1208 to direct the user to a post scores webpage.

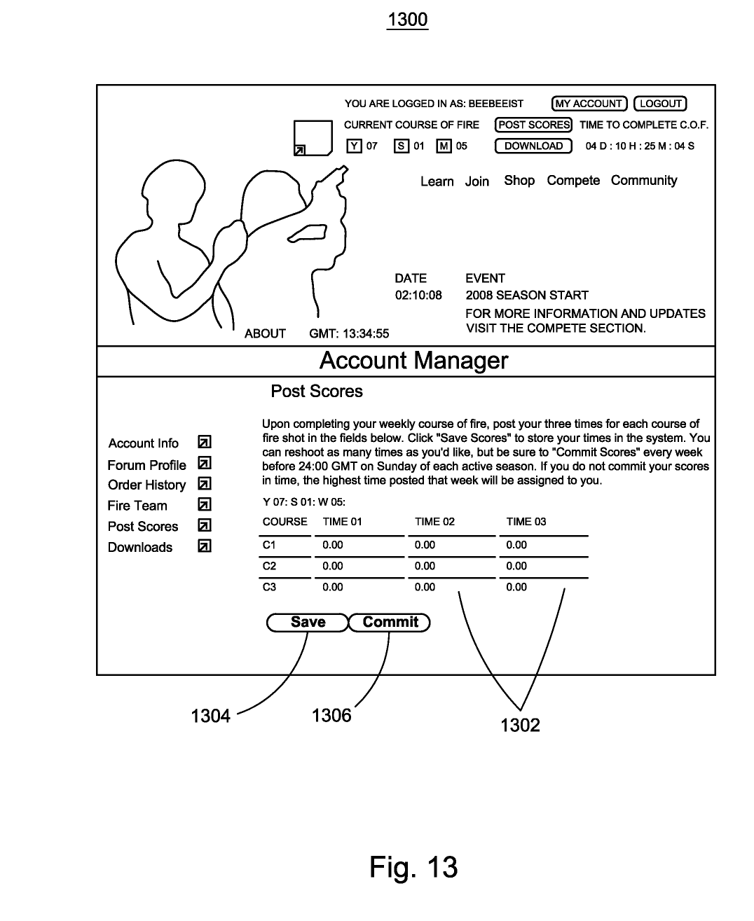

FIG. 13 depicts an example post scores webpage 1300 via which results may be uploaded from the participants. The post scores webpage 1300 enables a participant to enter multiple scores associated with each course-of-fire. The post scores webpage 1300 may provide one or more numerical form fields 1302 for receiving one or more scores from the user. The post scores webpage 1300 may associate three form fields 1302 per course-of-fire. The score may represent the total elapsed time that the user required to complete a course-of-fire.

The user may enter the three best times (i.e., lowest times) for each course-of-fire. The user may click the save score button 1304 to store the scores temporarily at the server. The user may edit times that have been saved and not committed. Then, when the user is ready to finalize participation in the current course-of-fire, the user may click the commit scores 1306 button to finalize the times. Once the user clicks the commit scores button, the scores will be committed to the server and the user may be prevented from changing those time.

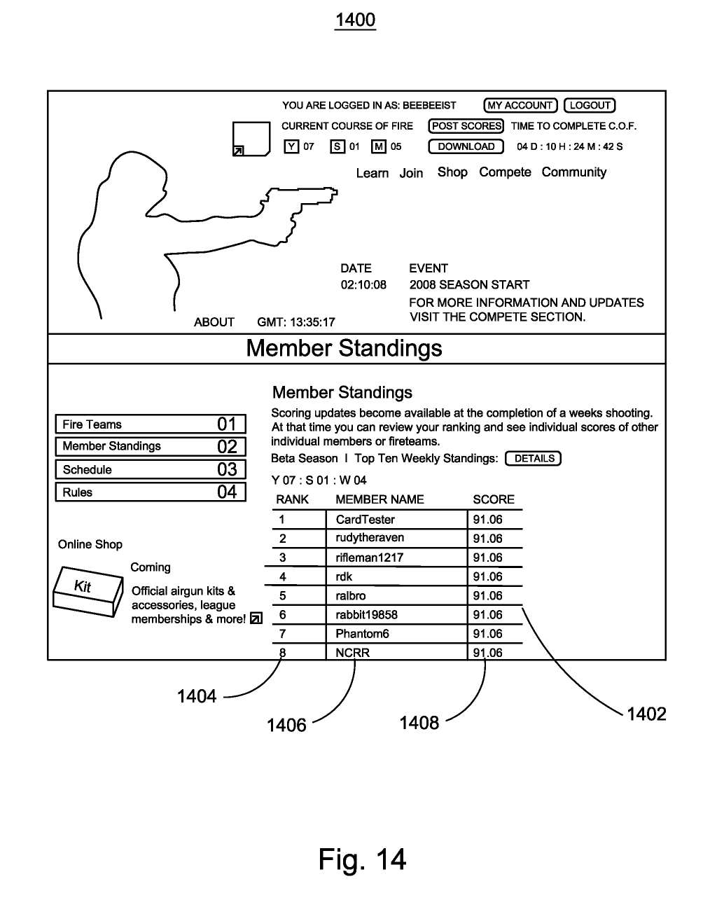

FIG. 14 depicts an example standings webpage 1400 for displaying results data 1402. The standings webpage 1400 enables a user to view the results data 1402 associated with a shooting sport competition. For example, the user may view rankings associated with a course-of-fire, a season, a championship competition, or the like. The standings webpage 1400 may present the rankings as scores for individuals and/or teams.

The displayed results data 1402 may include a ranking 1404, a member name 1406, and/or score 1408. The ranking 1404 may represent a user's overall comparison with other users. For example, the user ranked first may have the best score overall. The member name 1406 may correspond to the registration data provided by the individual user. The member name 1406 may identify the user within the shooting sport competition. The score 1408 may represent an overall numerical assessment of the user's performance within the shooting sport competition. For example, the score 1408 may be normalized to a 100 point scale.

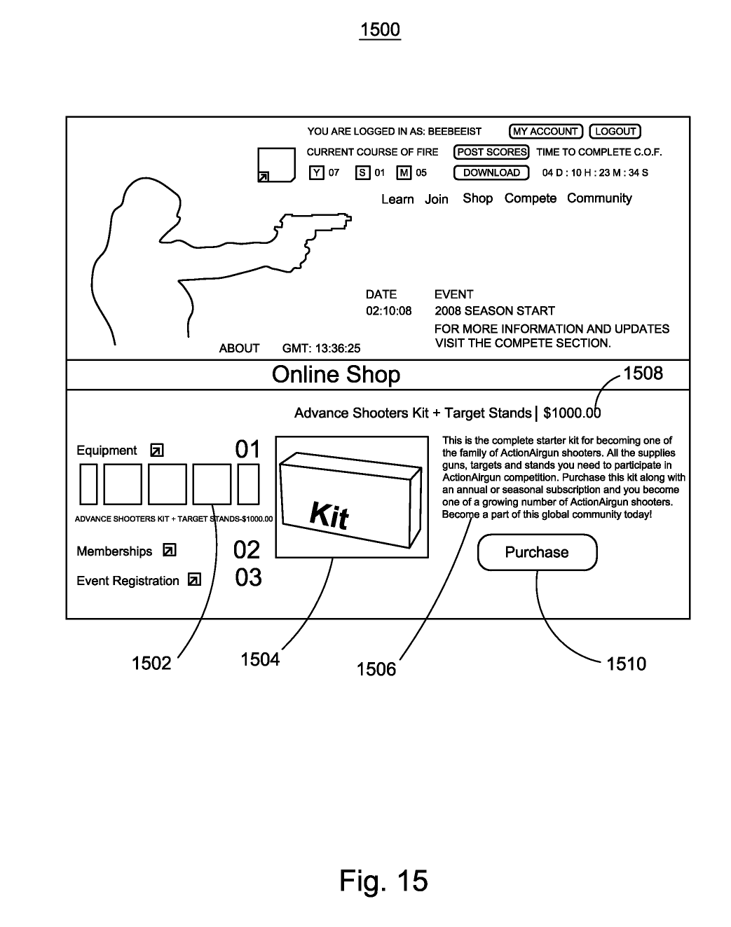

FIG. 15 depicts an example online store webpage 1500 from which one or more standard items may be purchased. The online store webpage 1500 may include one or more icons 1502. Each icon 1502 may be associated with one or more standard items available for purchase. The standard items may be suitable for participation in a distributed shooting sport competition. For example, the standard items may include a shooter's kit, targets, targets stands, or the like.

A user viewing the online store webpage 1500 may click on one of the icons 1502 to present more information about the selected standard item. The online store webpage may present a picture 1504 and a description 1506 of the selected item. In addition, the online store webpage may present the purchase price 1508 of the selected standard item. The user may indicate to the online store webpage 1500 an intention to purchase the selected standard item by clicking the purchase button 1510. clicking on the purchase button 1500 may initiate an e-commerce application. In accordance with the e-commerce application, the user may be prompted for billing information, shipping information, payment information, or the like. The e-commerce application may prompt order processing, payment verification, and shipping of the selected standard item. By providing the online store webpage in connection with the distributed action shooting sport competition organization and ranking, users may be provided with a known source from which to obtain standard items for use in the distributed action shooting sport competition.

While the present disclosure includes exemplary embodiments of the various figures, it is not limited thereto and it is to be understood that other similar embodiments may be used or modifications and additions may be made to the described embodiments for performing the same function of the present invention without deviating therefrom. Furthermore, it should be emphasized that a variety of computer platforms, including handheld device operating systems and other application specific operating systems are contemplated. Still further, the present invention may be implemented in or across a plurality of processing chips or devices, and storage may similarly be implemented across a plurality of devices. Therefore, the present invention should not be limited to any single embodiment, but rather should be construed in breadth and scope in accordance with the appended claims. Also, the appended claims should be construed to include other variants and embodiments of the invention, which may be made by those skilled in the art without departing from the true spirit and scope of the present invention.

What is claimed:

1. A computer-implemented method of enabling a real-life, physical activity for a plurality of geographically diverse participants, the method comprising:
distributing a rule-set to a plurality of geographically diverse participants, wherein the rule-set defines the real-life, physical activity, the rule-set requiring a foam airgun target for participation in the real-life, physical activity, and the rule-set specifying parameters for participation in the real-life, physical activity by each of the plurality of geographically diverse participants, and the rule-set specifying a plurality of respective metrics, each respective metric being indicative of an objective level of performance in completing the real-life, physical activity;
receiving the plurality of metrics; and
providing a ranking associated with the plurality of metrics and the plurality of geographically diverse participants, wherein the ranking is indicative of a relative level of performance in completing the real-life, physical activity.

2. The method of claim 1, wherein the real-life, physical activity comprises a human interaction with a first tangible object, wherein the first tangible object interacts with a second tangible object, the second tangible object being isolated over a distance from the first tangible object.

3. The method of claim 2, wherein the first tangible object comprises an airgun and an airgun pellet and wherein the second tangible object comprises an airgun target.

5. The method of claim 1, wherein the real-life, physical activity comprises an airgun shooting sport.

6. The method of claim 1, wherein providing the foam airgun target comprises selling the foam airgun target via an e-commerce server.

7. The method of claim 1, wherein the rule-set comprises a course-of-fire document.

8. The method of claim 7, the course-of-fire document comprises a first indication of position of a target stand, a second indication of position of the foam airgun target, a third indication of starting body position relative to an airgun, and a fourth indication of starting body position relative to the target stand.

9. The method of claim 7, wherein the course-of-fire document comprises a fifth indication of the status of a foam airgun target, wherein the status is one of shoot or no-shoot.

10. The method of claim 9, wherein the course-of-file document indicates that a first foam airgun target is to be placed with a no-shoot status to partially block a second foam airgun target with a shoot status, thereby reducing an effective target area of the second foam airgun target.

11. The method of claim 7, wherein the course-of-fire document specifies the size and shape of the foam airgun target.

12. The method of claim 1, wherein each respective metric comprises a respective elapsed time associated with each of the geographically diverse participants completion of the real-life, physical activity.

13. The method of claim 1, wherein receiving the metric comprises receiving a respective score from each of a plurality of participants.

14. The method of claim 1, further comprising assembling a kit that includes the foam airgun target and at least one other item required for participation in the real-life, physical activity.

15. A computer readable medium having stored thereon computer executable instructions that when executed perform a method, comprising:
providing a website for selling a foam airgun target;
distributing a rule-set to a plurality of geographically diverse participants, wherein the rule-set defines a real-life, physical activity, wherein the rule-set requires the first item for participation in the real-life, physical activity, and wherein participation in the real-life, physical activity by each of the plurality of geographically diverse participants generates a plurality of respective metrics, each respective metric being indicative of a objective level of performance in completing the real-life, physical activity;
enabling the website for receiving the plurality of metrics; and
providing a ranking data associated with the plurality of metrics and the plurality of geographically diverse participants, wherein the ranking data is indicative of a relative level of performance in completing the real-life, physical activity.

16. The computer readable medium of claim 16, wherein the rule-set comprises a course-of-fire document.

17. The computer readable medium of claim 17, wherein the course-of-fire document a first indication of position of a target stand, a second indication of position of an airgun target, a third indication of starting body position relative to an airgun, and a fourth indication of starting body position relative to the target stand.

18. The computer readable medium of claim 17, wherein the course-of-fire document comprises a fifth indication of the status of a foam airgun target, wherein the status is one of shoot or no-shoot.

19. The computer readable medium of claim 16, wherein the method further comprises receiving registration data from the plurality of geographically diverse participants, wherein the registration data is indicative of a respective identity for each of the plurality of geographically diverse participants.

20. A computer system comprising:
a memory for storing a rule-set and ranking data; and
a processor configured to:
distribute the rule-set to a plurality of geographically diverse participants, wherein the rule-set defines a real-life, physical activity, wherein the rule-set requires the first item for participation in the real-life, physical activity, and wherein participation in the real-life, physical activity by each of the plurality of geographically diverse participants generates a plurality of respective metrics, each respective metric being indicative of a objective level of performance in completing the real-life, physical activity;
provide a website for selling a foam airgun target;
enabling the website for receiving the plurality of metrics; and
generate the ranking data associated with the plurality of metrics and the plurality of geographically diverse participants, wherein the ranking data is indicative of a relative level of performance in completing the real-life, physical activity.
